(19) United States
(12) Patent Application Publication
(10) Pub. No.: US 2008/0273355 A1
(43) Pub. Date: Nov. 6, 2008

(54) Dual output programmable power supply

(75) Inventors: Narith L. Yos, San Jose, CA (US); Sanjay M. Prabhakaran, San Jose, CA (US)

Correspondence Address: Douglas E. Mackenzie, P.O. Box 1295, Mt. View, CA, 94042, US

(73) Assignee: Viventure Corp.

(21) Appl. No.: 11/799,717

(22) Filed: May 1, 2007

(51) Int. Cl. H02M 3/335

(52) U.S. Cl. 363/24

(57) ABSTRACT

A dual output programmable power supply is disclosed. The dual output programmable power supply includes an AC input train including an active power factor correction circuit, a half-bridge square wave driver coupled to the AC input train through a boot strap circuit, and a pair of primary side transistors coupled to a transformer, the primary side transistors being driven by the half-bridge square wave driver. Four transistors in a bridge configuration are coupled to a transformer secondary side and to a DC input, the four transistors being driven as a bridge of active synchronous rectifiers by a full-bridge gate driver in an AC mode of operation, and the four transistors being driven as a full-bridge square wave converter by the full-bridge gate driver in a DC mode of operation. A pair of DC/DC converters is coupled to an output of the four transistors in the bridge configuration, each DC/DC converter providing a regulated output. A programmable controller is coupled to the full-bridge gate driver and the pair of DC/DC converters, the programmable controller being operable to select between the AC and DC modes of operation and to regulate the DC/DC converter outputs.

### BACKGROUND OF THE INVENTION

1. Field of the Invention

The present invention relates to power supplies and more particularly to a dual output programmable power supply.

2. Description of Related Art

Existing power supplies with multiple outputs must provide a coordinated output control to make sure the sum of powers delivered to the multiple loads does not exceed the supply power limit. This is usually done by simplified means, such as by assigning individual power limits unevenly (one output is reserved for high power loads, one for smaller loads), or by assigning a sum of powers significantly lower than the total power capability of the supply. Another method measures current at a point upstream of the actual outputs. This is usually done with a current transformer, which is costly.

Power supplies that use resistors to program output voltages suffer the disadvantage of system inaccuracies due to resistor tolerances and inaccuracies of the analog circuits used to set the output voltages. Furthermore, such power supplies do not account for the actual load drawn by the load devices, which are likely much lower than their specified maximum limits, nor do such power supplies monitor the actual loads continuously.

There is therefore a need in the art for a dual output power supply that overcomes the limitations of the prior art. There is a further need for a dual output power supply that provides for independent load assignment. There is also a need for a dual output power supply that precisely matches the sum of the loads to the output capability of the power supply. There is a further need for a dual output power supply that provides precise output voltage and current limit programming. There is also a need for a dual output power supply having a compact design. There is a further need for a dual output power supply having versatile programming features that enable use with a wide variety of load devices. There is also a need for a dual output power supply that provides for reduced analog inaccuracies. There is a further need for a dual output power supply that provides for continuous load monitoring.

### SUMMARY OF THE INVENTION

The dual output programmable power supply of the invention meets these needs by providing a power supply designed to convert power from an AC line or from an external 12 volt source to two regulated outputs. A power supply programmable controller is operable to set the output voltages and output current limits of each of the two regulated outputs independently. In use with appropriate tip connectors, the power supply of the invention is capable of powering a wide variety of devices including PDAs, laptop computers, handheld computers, cell phones and gaming devices.

In accordance with another aspect of the invention, a dual output programmable power supply includes an AC input train including an active power factor correction circuit, a half-bridge square wave driver coupled to the AC input train through a boot strap circuit, and a pair of primary side transistors coupled to a transformer, the primary side transistors being driven by the half-bridge square wave driver. Four transistors in a bridge configuration are coupled to a transformer secondary side and to a DC input, the four transistors being driven as a bridge of active synchronous rectifiers by a full-bridge gate driver in an AC mode of operation, and the four transistors being driven as a full-bridge square wave converter by the full-bridge gate driver in a DC mode of operation. A pair of DC/DC converters is coupled to an output of the four transistors in the bridge configuration, each DC/DC converter providing a regulated output. A programmable controller is coupled to the full-bridge gate driver and the pair of DC/DC converters, the programmable controller being operable to select between the AC and DC modes of operation and to regulate the DC/DC converter outputs.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of functional components and to the arrangements of these components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a schematic representation of a dual output power supply circuit in accordance with the invention; and

FIG. 2 is a schematic representation of an alternative embodiment of the power supply circuit having a single output in accordance with the invention.

### DETAILED DESCRIPTION OF A PREFERRED EMBODIMENT OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

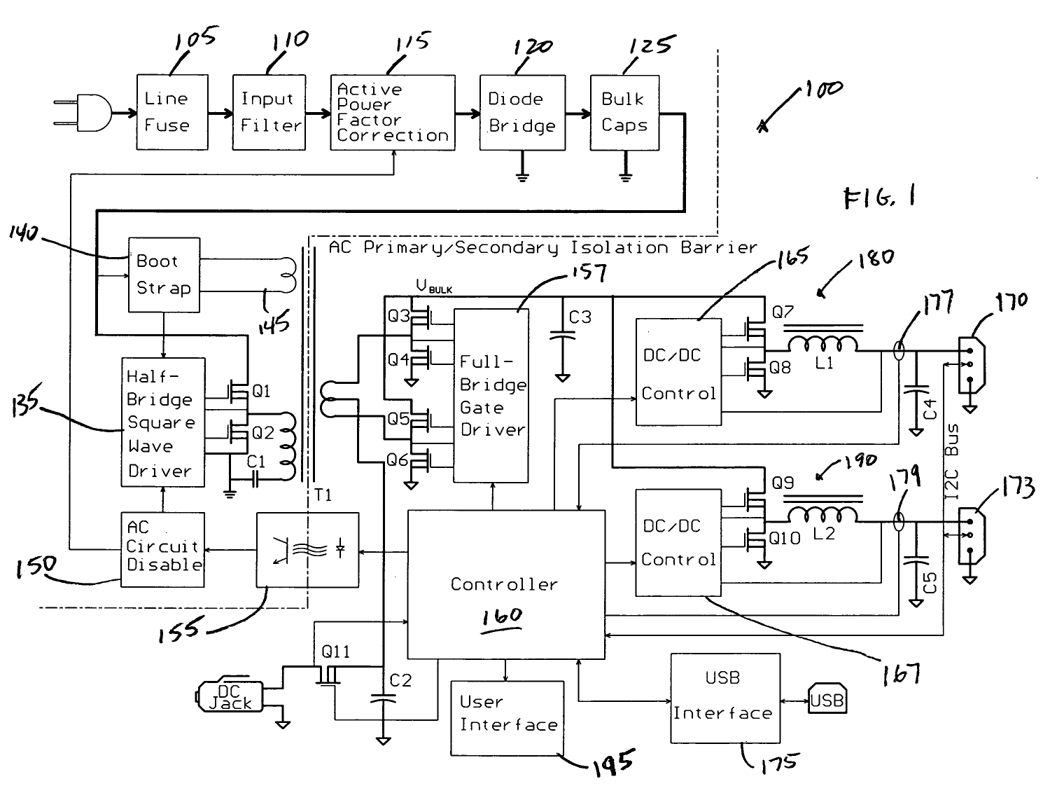

An exemplary embodiment of a dual output programmable power supply 100 in accordance with the invention is shown in FIG. 1. Power supply 100 includes an AC input power train comprising a line fuse 105, an input filter 110, an active power factor correction circuit 115, a diode bridge 120 and bulk capacitors 125 as is known in the art. The active power factor correction circuit 115 is disabled during battery operation to prevent power consumption as further detailed below.

The active power factor correction circuit 115 provides compliance with European harmonic current regulations and similar requirements in other countries. In addition, the active power factor correction circuit 115 provides rough regulation of the input voltage to the AC power converter. Thus, over a worldwide range of input voltages from 88 to 269 V_{AC}, the voltage exiting the active power factor correction circuit 115 is about 360 V_{DC}.

The AC power converter circuit is implemented as a half-bridge square wave converter. Transistors Q1 and Q2 are driven by a half-bridge square wave driver 135. The half-bridge square wave driver 135 is powered by a boot strap circuit 140 which provides a small amount of line current to start the half-bridge square wave driver 135. Once operating, the boot strap circuit 140 delivers power to the half-bridge square wave driver 135 from the takeover bias winding 145 of transformer T1.

During operation from the AC line source, a secondary side full-bridge gate driver 157 drives secondary side transistors Q3, Q4, Q5, and Q6 in direct response to the voltages on transformer T1. In this mode of operation, transistors Q3, Q4, Q5, and Q6 operate as a bridge of active synchronous rectifiers to improve overall circuit efficiency. The output voltage, V_{BULK}, is unregulated since the half-bridge square wave driver 135 has no control feedback and ranges from 20 to 26 volts, depending mainly on the AC line voltage and the load current.

Two identical DC/DC converters generally designated 180 and 190 on the secondary side convert V_{BULK} to regulated output voltages V_{OUT1} and V_{OUT2} at output connectors 170 and 173 respectively. DC/DC converter 180 comprises a DC/DC control circuit 165, transistors Q7 and Q8, inductor L1 and capacitor C4. DC/DC converter 190 comprises a DC/DC control circuit 167, transistors Q9 and Q10, inductor L2 and capacitor C5. DC/DC converters 180 and 190 also implement a rough current limit to prevent gross overload, which would occur if the load were to become shorted. The output voltages and current limit settings of DC/DC converters 180 and 190 are set by a programmable controller 160.

The programmable controller 160 determines the output voltages and current limits that are to be set by reading tips (not shown) coupled to output connectors 170 and 173. Tips include an EEPROM in which the desired output voltage and limit current is programmed. The tips are read through an 12C bus coupled to the output connectors 170 and 173. Alternatively, the programmable controller 160 sets the output voltages and current limits in response to external programming through a USB interface 175.

An AC circuit disable circuit 150 is operable to disable both the half-bridge square wave driver 135 as well as the active power factor correction circuit 115 to prevent simultaneous operation of the AC line-powered circuit and the DC battery-powered circuit. The AC circuit disable circuit 150 receives a signal representing operation from a DC source from an opto-isolator 155 driven by the programmable controller 160 on the secondary side. Simultaneous operation of the AC line-powered circuit and the DC battery-powered circuit would lead to asynchronous operation of the AC and DC circuits and cause events of simultaneous conduction among the circuit transistors, destroying the devices.

During battery operation, transistors Q3, Q4, Q5, and Q6 operate as a full-bridge square wave converter. In this mode, Q3 and Q6 operate simultaneously, followed sequentially by Q4 and Q5. Unlike in the AC mode of operation, transistors Q3, Q4, Q5, and Q6 are driven in response to a signal from the programmable controller 160 and not from the voltage on T1. Transistors Q3, Q4, Q5, and Q6 effectively double the voltage from the battery, achieving a V_{BULK} of 20 to 26 volts, depending upon the voltage of the battery and the load current. During DC operation, transformer T1 generates a high voltage on the primary side that charges capacitor C1. Since the AC circuit is disabled, this voltage has no effect upon the operation of the power supply.

Transistor Q11 is provided to disconnect the battery from the supply during AC operation to prevent the circuit from inadvertently charging the battery.

During operation, load current measurements are made on the output lines 177 and 179. A signal representing the measured currents is input to the programmable controller 160 wherein a determination is made whether the load currents exceed a pre-programmed limit. If the pre-programmed limit is exceeded, the programmable controller 160 disables the output having the excessive load current.

The programmable controller 160 includes a microprocessor, D/A and A/D converters. The programmable controller 160 controls all operational aspects of the power supply 100 including the selection of either the AC or DC input source and a corresponding AC or DC mode of operation. The selection of either the AC or DC input source is preferably done on a first come first served basis, the input source that first energizes the programmable controller 160 being selected.

The programmable controller 160 also sets DC/DC converters 180 and 190 and monitors load currents to ensure that the sum of the two output power levels does not exceed the rating of the power supply. The programmable controller 160 is operable to disable the outputs at output connectors 170 and 173 in the event that the sum exceeds the rating. The programmable controller 160 further controls communications with a PC (not shown) through the USB interface 175 and communications with the EEPROMs contained in tips coupled to the output connectors 170 and 173.

The USB interface 175 can be advantageously used to reprogram the EEPROMs in tips coupled to the output connectors 170 and 173. The programming of the EEPROMs simplifies the development of tips for existing and new products. A new product requires a tip that mechanically matches the power connector of the device being powered by the power supply 100. The voltage and current limit of the tip can be assigned by programming the tip and the inventory of tips that must be maintained reduced thereby.

The USB interface 175 can also be used to program the programmable controller 160 to carry out other useful functions such as shutting down an output after a period of time. This feature could also be used to time-limit access to a connected device, such as a child's game.

The USB interface 175 can further be used to monitor the power supply 100 outputs. Each load can be monitored and displayed on a PC as a graph of power consumed over time, or a similar presentation of power consumption data. This feature can be used in new product development and as a diagnostic tool to determine whether a device is working properly.

The USB interface 175 can also be used to program tips having EEPROMs to adjust the voltage assigned to a particular device. Small adjustments in the output voltage can be made to solve a particular problem.

In an aspect of the invention, a user interface 195 is coupled to the programmable controller 160. The user interface 195 may include LEDs (not shown) and an LCD (not shown) operable to indicate to a user the status of the outputs including voltage and current levels and other useful information.

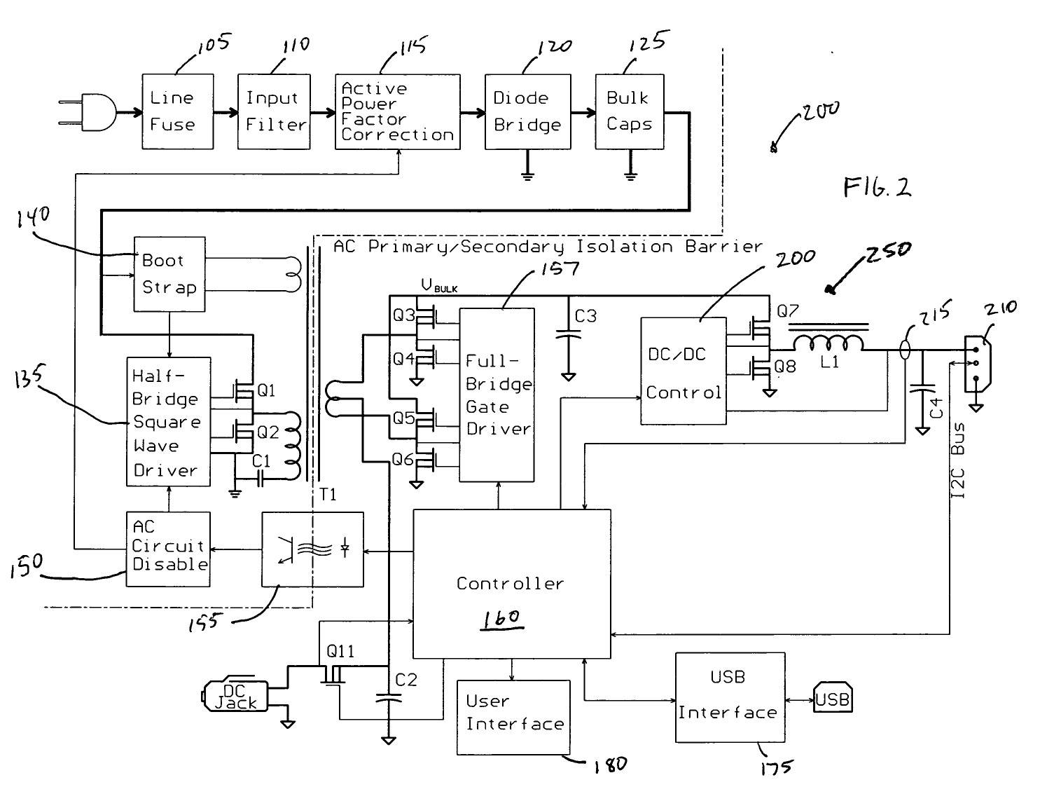

While the programmable power supply has been described as having two outputs, one skilled in the art will appreciate that the circuit can be implemented with a single output to take advantage of the novel circuit design features. An alternative programmable power supply 200 is shown in FIG. 2 and includes identical circuit components as the dual programmable power supply 100 with the exception that only one DC/DC converter generally designated 250 is coupled to the programmable controller 160. An output connector 210 is shown connected to the DC/DC converter 250.

During operation load current measurements are made on the output line 215. A signal representing the measured current is input to the programmable controller 160 wherein a determination is made whether the load current exceeds a pre-programmed limit. If the pre-programmed limit is exceeded, the programmable controller 160 disables the output.

It is apparent that the above embodiments may be altered in many ways without departing from the scope of the invention. Further, various aspects of a particular embodiment may contain patentably subject matter without regard to other aspects of the same embodiment. Still further, various aspects of different embodiments can be combined together. Accordingly, the scope of the invention should be determined by the following claims and their legal equivalents.

What is claimed is:

1. A dual output programmable power supply comprising:
an AC input train including an active power factor correction circuit;
a half-bridge square wave driver coupled to the AC input train through a boot strap circuit;
a pair of primary side transistors coupled to a transformer, the primary side transistors being driven by the half-bridge square wave driver;
a secondary side full-bridge gate driver;
four transistors in a bridge configuration coupled to a transformer secondary side and to a DC input, the four transistors being driven as a bridge of active synchronous rectifiers by the full-bridge gate driver in an AC mode of operation, and the four transistors being driven as a full-bridge square wave converter by the full-bridge gate driver in a DC mode of operation;
a pair of DC/DC converters coupled to an output of the four transistors in the bridge configuration, each DC/DC converter providing a regulated output; and
a programmable controller coupled to the full-bridge gate driver and the pair of DC/DC converters, the programmable controller being operable to select between the AC and DC modes of operation and to regulate the DC/DC converter outputs.

2. The dual output programmable power supply of claim 1, wherein the programmable controller is operable to control the full-bridge gate driver to drive the four transistors in the bridge configuration as a full-bridge square wave converter in the DC mode of operation.

3. The dual output programmable power supply of claim 1, wherein the full bridge gate driver is responsive to the transformer secondary in the AC mode of operation.

4. The dual output programmable power supply of claim 1, further comprising a USB interface coupled to the programmable controller.

5. The dual output programmable power supply of claim 1, further comprising a user interface coupled to the programmable controller.

6. The dual output programmable power supply of claim 1, further comprising an AC circuit disable circuit coupled to the programmable controller through an opto-isolator, the AC circuit disable circuit being operable to disable the half-bridge square wave driver and the active power factor correction circuit.

7. The dual output programmable power supply of claim 1, wherein the programmable controller is operable to select between the AC and DC input on a first come first served basis.

8. The dual output programmable power supply of claim 1, wherein the programmable controller is operable to set output voltages and output current limits of respective outputs of the DC/DC converters.

9. The dual output programmable power supply of claim 1, wherein the programmable controller is operable to measure load currents of respective outputs of the DC/DC converters

10. The dual output programmable power supply of claim 9, wherein the programmable controller is operable to disable either of the outputs of the DC/DC converters in the case where the measured load current exceeds a pre-determined limit, and to disable both the outputs of the DC/DC converters in the case where a measured sum of powers exceeds a pre-determined limit.

11. A dual output programmable power supply for supplying two DC outputs from either an AC line input or a DC input comprising:
an AC input train;
a half-bridge square wave driver coupled to the AC input train;
a pair of primary side transistors coupled to a transformer, the primary side transistors being driven by the half-bridge square wave driver;
a secondary side full bridge gate driver;
four transistors in a bridge configuration coupled to a transformer secondary side and to the DC input, the four transistors being driven as a bridge of active synchronous rectifiers by the full-bridge gate driver in an AC mode of operation, and the four transistors being driven as a full-bridge square wave converter by the full-bridge gate driver in a DC mode of operation;
a pair of DC/DC converters coupled to an output of the four transistors in the bridge configuration, each DC/DC converter providing a regulated output; and
a programmable controller coupled to the full-bridge gate driver and the pair of DC/DC converters, the programmable controller being operable to select between the AC and DC modes of operation and to regulate the DC/DC converter outputs.

12. The dual output programmable power supply of claim 11, wherein the programmable controller is operable to control the full-bridge gate driver to drive the four transistors in the bridge configuration as a full-bridge square wave converter in the DC mode of operation.

13. The dual output programmable power supply of claim 11, wherein the full bridge gate driver is responsive to the transformer secondary in the AC mode of operation.

14. The dual output programmable power supply of claim 11, further comprising a USB interface coupled to the programmable controller.

15. The dual output programmable power supply of claim 11, further comprising an AC circuit disable circuit coupled to the programmable controller through an opto-isolator, the AC circuit disable circuit being operable to disable the half-bridge square wave driver and an active power factor correction circuit in the AC input train.

16. The dual output programmable power supply of claim 11, wherein the programmable controller is operable to select between the AC and DC input on a first come first served basis.

17. The dual output programmable power supply of claim 11, wherein the programmable controller is operable to set output voltages and output current limits of respective outputs of the DC/DC converters.

18. The dual output programmable power supply of claim 11, wherein the programmable controller is operable to measure load currents of respective outputs of the DC/DC converters.

19. The dual output programmable power supply of claim 18, wherein the programmable controller is operable to disable either of the outputs of the DC/DC converters in the case where the measured load current exceeds a pre-determined limit, and to disable both the outputs of the DC/DC converters in the case where a measured sum of powers exceeds a pre-determined limit.

20. A programmable power supply for supplying a DC output from either an AC line input or a DC input comprising:
an AC input train;
a half-bridge square wave driver coupled to the AC input train;
a pair of primary side transistors coupled to a transformer, the primary side transistors being driven by the half-bridge square wave driver;
a secondary side full bridge gate driver;
four transistors in a bridge configuration coupled to a transformer secondary side and to the DC input, the four transistors being driven as a bridge of active synchronous rectifiers by the full-bridge gate driver in an AC mode of operation, and the four transistors being driven as a full-bridge square wave converter by the full-bridge gate driver in a DC mode of operation;
a DC/DC converter coupled to an output of the four transistors in the bridge configuration, the DC/DC converter providing a regulated output; and
a programmable controller coupled to the full-bridge gate driver and the DC/DC converter, the programmable controller being operable to select between the AC and DC modes of operation and to regulate the DC/DC converter output.
